(19) United States
(12) Patent Application Publication
(10) Pub. No.: US 2009/0248548 A1
(43) Pub. Date: Oct. 1, 2009

(54) METHOD FOR LOCATION BASED INVENTORY LOOKUP

(75) Inventor: Lance Obermeyer, Austin, TX (US)

Correspondence Address: John A. Fortkort;Fortkort & Houston P.C., Suite 500, 9442 N. Capital of Texas Hwy, Building 1, Austin, TX, 78759, US

(73) Assignee: 30 Second Software, Inc.

(21) Appl. No.: 12/410,775

(22) Filed: Mar. 25, 2009

Related U.S. Application Data
(60) Provisional application No. 61/072,092, filed on Mar. 26, 2008.

(51) Int. Cl. G06Q 30/00; G06F 19/00; G01C 21/00

(52) U.S. Cl. 705/28; 701/300; 701/207; 705/26

(57) ABSTRACT

A method is provided which enables a user of a mobile communications device to identify a local vendor of a product or service of interest to the user. In accordance with the method, input is received from the user regarding a product or service of interest to the user. The location of the mobile communications device is then determined through a location determination algorithm. Vendor information is then obtained which identifies vendors which are local to the determined location, and status information is obtained which identifies the availability of the product or service of interest at the identified vendors.

### CROSS-REFERENCE TO RELATED APPLICATION

This application claims the benefit of priority from U.S. Provisional Application No. 61/072,092, filed Mar. 26, 2008, having the same title and inventor, and which is incorporated herein by reference in its entirety.

### FIELD OF THE DISCLOSURE

The present disclosure relates generally to mobile communications devices, and more particularly to methods and systems for enabling users of these devices to find products or services of interest to them which are available at local merchants.

### BACKGROUND OF THE DISCLOSURE

Various methods are known to the art for determining the location of a mobile communications device. For example, location may be determined through the use of the Global Positioning System (GPS), or through triangulation based on the location of nearby cell towers (Cell ID).

GPS is a satellite-based system in which satellites continually broadcast information about their locations, and receivers receive these broadcasts. The receivers then perform a triangulation calculation on the received location information in order to determine the point in space where the device is located. The Cell ID method, by contrast, works by determining the location of the nearest cell towers. This is usually accomplished by determining the identifiers of the connected cell towers. These locations are then triangulated to determine the point in space corresponding to the location of the mobile communications device.

Regardless of the method employed, most modern mobile communications devices are able to determine their location (commonly expressed in terms of latitude and longitude) within an acceptable range of uncertainty. This information may be displayed to the user of a mobile communications device in a variety of formats. One approach currently in vogue involves displaying a map of the local region, along with a token or symbol indicating the current location of the mobile communications device within that region. In some applications, the map information is augmented with a marked destination point, and driving directions are provided for efficiently traveling from the current location to the destination point. Other applications may also be provided as part of the associated software package, including asset tracking (for tracking the movement of goods over a delivery route) and “friend finder” programs (for displaying the location of other mobile communications devices of interest to the user).

Various electronic commerce services are also currently known to the art. The concept of buying and selling devices over the Internet through online vendors is well established. At present, many vendors, such as the Barnes & Noble chain of book stores, have both an online presence and physical locations. These so called “Clicks and Mortar” vendors often have a “Find in Store” feature on their web site that provides an inventory lookup service. This service allows a user to determine whether an item is available at a specific store. This process is typically implemented through a real-time link between the vendor's web site and a store's inventory system.

A mobile communications device typically connects to an ecommerce system through the use of a “mobile browser”, which is typically the software browser included in the software package or operating system of the mobile communications device. Vendors engaging in ecommerce may require users from mobile browsers to connect directly to their regular web site, or they may make a special web site (or a special version of the regular web site) available to such users which is optimized for the peculiar constraints of mobile browsers (such as reduced screen size).

### BRIEF DESCRIPTION OF THE DRAWINGS

FIG. 1 is an illustration of a mobile communications device showing a screenshot of the results page generated in response to a query made in accordance with the methodologies disclosed herein.

FIG. 2 is an illustration of a network setup suitable for implementing the systems and methodologies described herein.

FIG. 3 is a flow chart illustrating an embodiment of the methodologies described herein.

FIGS. 4-5 are a flow chart illustrating an embodiment of the methodologies described herein.

### SUMMARY OF THE DISCLOSURE

In one aspect, a method is provided for enabling a user of a mobile communications device to identify a local vendor of a product or service. The method comprises (a) receiving input from the user regarding a product or service of interest to the user; (b) determining the location of the mobile communications device through a location determination algorithm; (c) obtaining vendor information identifying vendors which are local to the determined location; and (d) obtaining status information identifying the availability of the product or service of interest at the identified vendors.

In another aspect, a method is provided for determining whether a product of interest to a user with a mobile device is in stock at a nearby store. The method comprises (a) receiving location information and item information from the mobile device, wherein the location information contains data about the current location of the mobile device, and wherein the item information contains data about an item of interest to the user; (b) sending the location information to a second network node; (c) receiving from the second network node store information relating to stores in the proximity of the user's current location; (d) sending the item information and store information to a third network node; (e) receiving status information from the third network node, wherein the status information contains data relating to the availability of the item in at least one store in the proximity of the user's current location; and (f) sending the status information to the mobile device.

In a further aspect, a system is provided for determining whether a product of interest to a user with a mobile device is in stock at a nearby store. The system comprises (a) a network adapted to support communications between a mobile device and a first server; (b) a mobile device in communication with the network, wherein the mobile device is adapted to determine its location through a location determination algorithm, and wherein the mobile device is further adapted to allow the user to select a product in order to determine whether the product is in-stock at any nearby stores; (c) a first server adapted to (i) receive location information and item information from the mobile device via the network, wherein the location information contains data about the current location of the mobile device, and wherein the item information contains data about an item of interest to the user, (ii) send the location information to a second server, (iii) receive from the second server store information relating to stores in the proximity of the user's current location, (iv) send the item information and store information to a third server, (v) receive status information from the third server, wherein the status information contains data relating to the availability of the item in at least one store in the proximity of the user's current location, and (vi) send the status information to the mobile device.

### DETAILED DESCRIPTION

Attempts to link location and inventory lookup in mobile applications have, to date, been unsatisfactory. This is due, in part, to the fact that previously proposed solutions have required users of a mobile communications devices to enter their location information, typically by specifying a current address or a subset thereof (such as a city/state or zip code). This requires that the user already know where they are, a condition which is often not the case in situations where systems of this type would be of most use. It has now been found that this shortcoming may be overcome by having the mobile communications device supply the location information. Hence, the systems and methodologies disclosed herein remove the requirement that the user already know where they are by substituting a location provided by the mobile communications device.

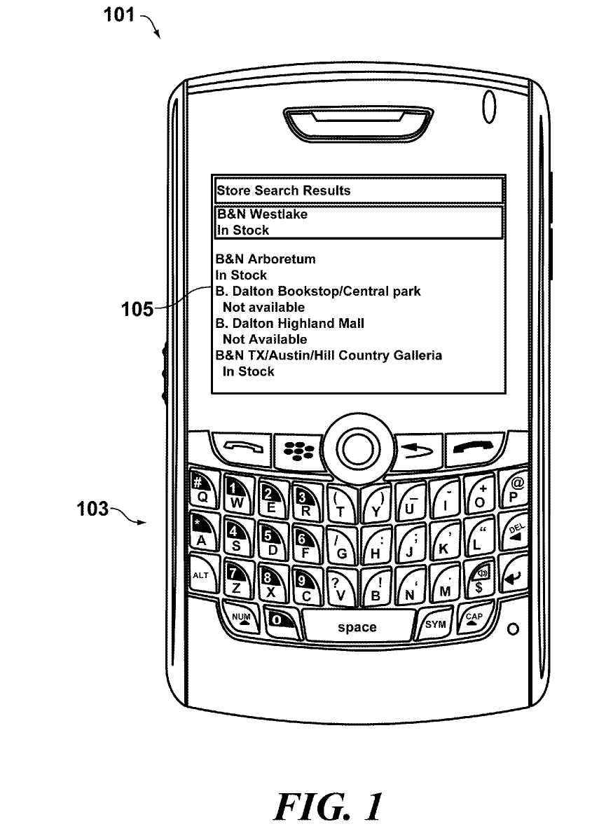

A variety of mobile communications devices are currently known to the art. One particular, non-limiting example of such a device is depicted in FIG. 1. The device 101 shown therein has a built-in keyboard 103 which may be used to input search requests and other such commands, and a display screen 105 which may be used to display search results.

Many mobile communications devices, such as RIM BLACKBERRY®, Apple iPHONE®, and Motorola RAZR® devices, have the ability to determine where they are. This ability for “Location Based Services” is perhaps best exemplified by programs that provide mapping and driving directions, such as TeleNav's GPS NAVIGATOR™. Similarly, these devices also have the ability to engage in electronic commerce. Specifically, users of these devices can view products at vendor web sites through a mobile browser included with these devices, or through a native application. Methods, systems and devices are disclosed herein which link these two capabilities, specifically by enabling a mobile communications device to inform a user whether a desired product or service is in stock or is available at nearby vendors.

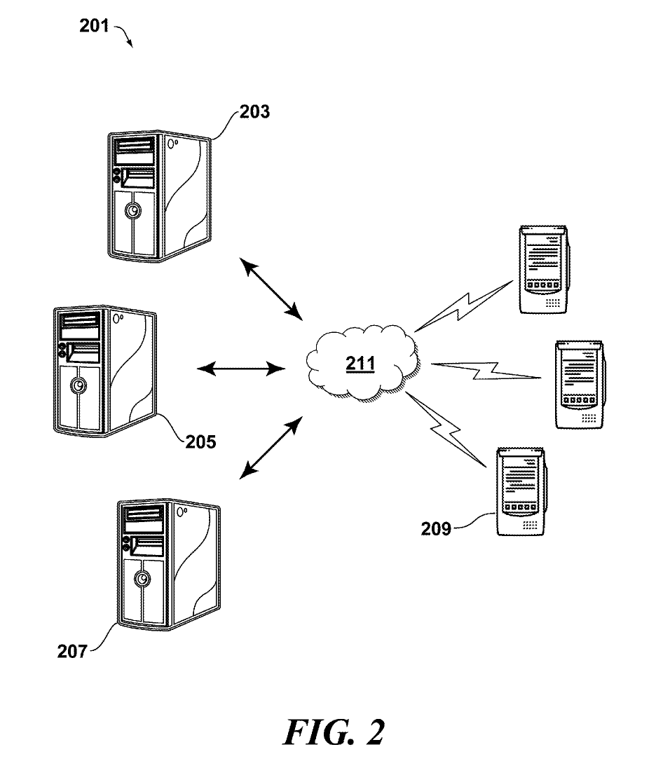

One particular, non-limiting example of a system which may be utilized to implement the methodologies disclosed herein is depicted in FIG. 2. The system 201 depicted therein comprises a commerce server 203, a store look-up server 205, and a store inventory server 207, which are in communication with a plurality of mobile communications devices 209 over a network 211.

The mobile communications device 209 utilized in the system 201 of FIG. 2 may be of the type depicted in FIG. 1, and preferably has the ability to determine its location within an acceptable range. For example, the mobile communications device 209 may have the ability to receive and process GPS signals, the ability to access and report the identifiers of one or more nearby cell towers that can be subsequently used to look up the location of the tower, or may be provided with other suitable means of ascertaining its location.

The store inventory server 207 preferably has the ability to respond to a suitable query with the inventory status of a defined item at a defined store. The store lookup server 205 preferably has the ability to respond to a suitable query with the set of stores close to a defined location. The commerce server 203 preferably includes the ability to receive location commands from a mobile communications device 209 and to send commands to one or more vendor servers.

The store lookup server 205 and the store inventory server 207 may be the property of the organization offering the location-based inventory lookup service, or may be the property of a third party. Such a third party may be, for example, a vendor such as a “clicks-and mortar” retailer. If the store lookup server 205 and store inventory server 207 are the property of a third party, they may be accessed through a public website or through a private connection. Moreover, although the servers 203-207 are depicted as discrete entities, it will be appreciated that, in some embodiments, some or all of these servers may be combined into a single server or network device. Similarly, in some embodiments, the functionalities performed by any one of the depicted servers may instead be implemented over a plurality of servers or other network devices.

The network 211 will typically be a wide area network (WAN) such as the Internet. In some embodiments, however, the network 211 may be a local area network (LAN) or a combination of networks. Preferably, the mobile communications devices 209 will access the network 211 wirelessly.

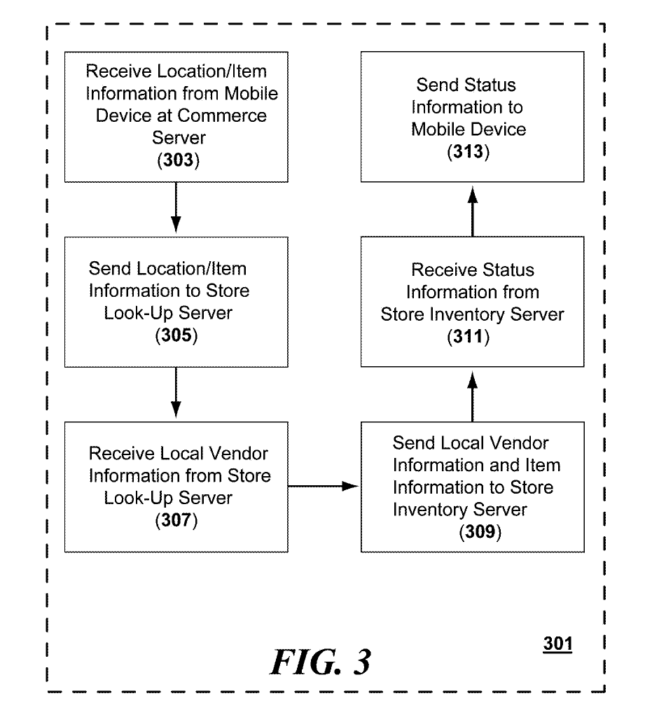

FIG. 3 illustrates, at a high level, the process flow attendant to a particular, preferred embodiment of the methodology disclosed herein. In the method 301 depicted therein, location and item information is received 303 from a user at a commerce server. The location information will typically include information about the geographic location of the user based on the location determined from the user's mobile communications device, and the item information will typically include information about an item or service of interest to the user.

The commerce server then sends 305 the location/item information to the store look-up server, and receives 307 local vendor information from the store look-up server. The local vendor information will typically include information about vendors who are in proximity to the determined location, and may also identify which of the local vendors provides the general type of goods or services sought by the user.

The commerce server then sends 309 the local vendor information and item information to the store inventory server, and receives 311 status information from the store inventory server. The status information may include, for example, information about the availability of the desired goods or services at any local vendor that provides the desired goods or services. The commerce server then transmits 313 the status information to the user's mobile communications device.

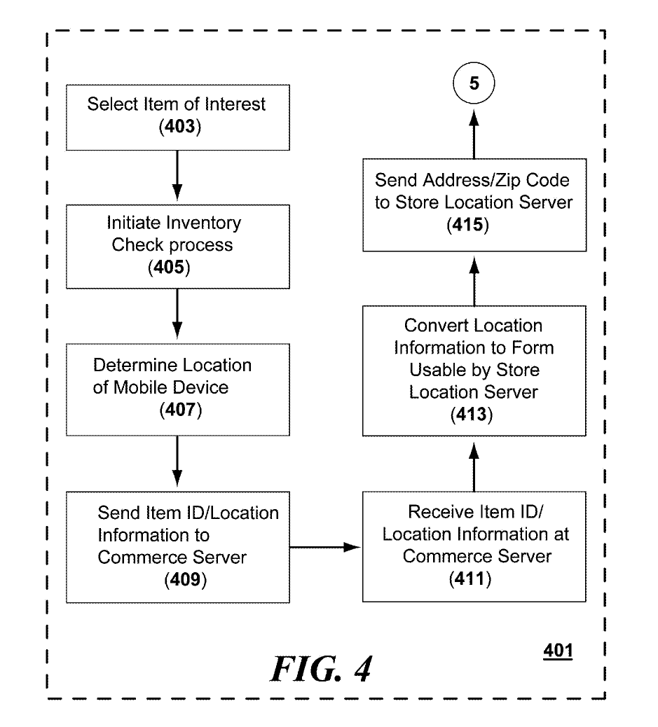

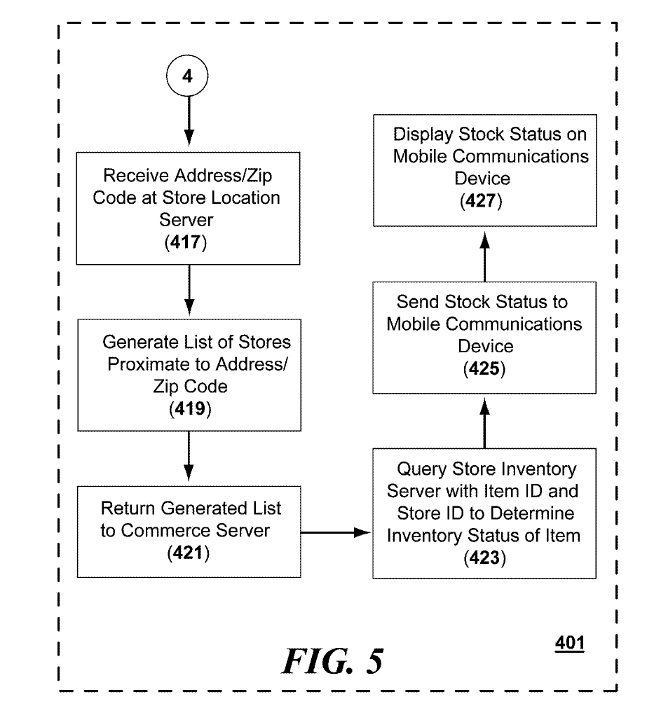

FIGS. 4-5 illustrate, in greater detail, the process flow attendant to a particular, preferred embodiment of the methodology disclosed herein. The location-based inventory check process 401 depicted therein begins with the user selecting 403 an item of interest from a vendor. This selection may be made, for example, by browsing a catalog which may be stored locally on the mobile communications device, or which may be accessed from a remote server.

After the user selects an item of interest, the inventory check process is initiated 405. As an initial part of this process, the mobile communications device determines 407 its location. Location determination may be accomplished through GPS-based geolocation, Cell ID-based geolocation, or by other suitable means. In the case of GPS-based geolocation, the location is typically expressed as a latitude/longitude pair. In the case of a cell ID-based geolocation, the location is typically expressed as a tower identifier.

The mobile communications device then sends 409 the item identifier and location information to the commerce server. The commerce server receives 411 the item identifier and location information from the mobile device, and converts 413 the location information received from the mobile device into a form usable by the store location server. This form is typically an address or zip code. In the case of a latitude/longitude pair, the commerce server consults an external service that returns the address or zip code of the location. In the case of a cell tower identifier, the commerce server consults an external service that returns either an address for the tower, or a latitude/longitude for the tower.

Once the address or zip code of the user is available, the commerce server sends 415 the address or zip code to the store location server. The store location server receives 417 the address or zip code and generates 419 a list of stores close to the desired address or zip code. The list of nearby stores is then returned 421 to the commerce server. The list preferably contains a unique store identifier for each store.

For each nearby store, the commerce server queries 423 the store inventory server with the item identifier and store identifier to determine the inventory status of the item at the defined store. The inventory status may include the number of units at the store, the date units arrive at the store, or other information about the item at the store. The commerce server responds 425 to the mobile communications device with the stock status of the item at one or more nearby stores. The mobile communications device displays 427 the stock status information about the item at one or more nearby stores. The status display may formatted as a list, on a map, or in another suitable representation.

### EXAMPLE 1

FIG. 1 shows a screen shot of a RIM BlackBerry® device depicting the result of a location-based inventory lookup in accordance with the methodology described above. In this particular example, the mobile communications device was located in Austin, Tex. and the item of interest was a DVD from Barnes & Noble Booksellers. As can be seen from the screenshot, the item was available at 3 out of the 5 stores.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A system for determining whether a product of interest to a user with a mobile communications device is in stock at a nearby store, comprising:
a network adapted to support communications between a mobile communications device and a first server;
a mobile communications device in communication with the network, wherein the mobile communications device is adapted to determine its location through a location determination algorithm, and wherein the mobile communications device is further adapted to allow the user to select a product in order to determine whether the product is available at any nearby vendor locations;
a first server adapted to
(a) receive location information and item information from the mobile communications device via the network, wherein the location information contains data about the current location of the mobile communications device, and wherein the item information contains data about an item of interest to the user,
(b) send the location information to a second server,
(c) receive from the second server vendor information relating to vendor locations in the proximity of the user's current location,
(e) send the item information and vendor information to a third server,
(f) receive status information from the third server, wherein the status information contains data relating to the availability of the item in at least one vendor location in the proximity of the user's current location, and
(g) send the status information to the mobile communications device.

2. The system of claim 1, wherein the second server is adapted to determine stores of a specified vendor in the proximity of the user's location.

3. The system of claim 1, wherein the third server is adapted to determine whether an identified store has an identified item in stock.

4. The system of claim 1, where location is determined (a) on the mobile communications device using the Global Positioning System, or (b) by using Cell Tower Triangulation of the known locations of one or more connected or nearby cell towers.

5. The system of claim 1, where the store lookup server and store inventory server are masked by a combination server such that a single request to the server for the status of an item near a location returns a list of nearby stores and their respective stock status of the item.

6. The system of claim 1, wherein the first server converts the received location information into a postal code.

7. A method for determining whether a product or service of interest to a user with a mobile device is in stock or available at a nearby vendor location, comprising:
receiving location information and item information from the mobile communications device, wherein the location information contains information about the current location of the mobile communications device, and wherein the item information contains information about a product or service of interest to the user;
sending the location information to a second network node;
receiving from the second network node vendor information containing information about vendor locations in the proximity of the current location of the mobile communications device;
sending the item information and vendor information to a third network node;
receiving status information from the third network node, wherein the status information contains information relating to the availability of the product or service in at least one vendor location in the proximity of the current location of the mobile communications device; and
sending the status information to the mobile communications device.

8. The method of claim 7, wherein the location information and item information are received at a first network node from the mobile communications device over a network.

9. The method of claim 7, wherein the first, second and third network nodes are servers.

10. The method of claim 7, wherein the second network node is adapted to identify locations of a specified vendor in the proximity of the user's location, and wherein the third network node is adapted to determine whether an identified location has a product which is of interest to the user in stock.

11. The method of claim 7, where location is determined by (a) using the Global Positioning System, or (b) by using Cell Tower Triangulation of the known locations of one or more connected or nearby cell towers.

12. The method of claim 11, wherein location is determined by using Cell Tower Triangulation of the known locations of one or more connected or nearby cell towers, and wherein the triangulation occurs (a) on the mobile communications device, or (b) on a server computer.

13. The method of claim 7, where the second and third network nodes are masked by a combination server such that a single request to the combination server for the status of an item near a location returns a list of nearby stores and their respective stock status of the item.

14. The method of claim 7, wherein the first network node is a commerce server, wherein the second network node is a store look-up server, and wherein the third network node is a store inventory server.

15. The method of claim 7, wherein the first network node converts the received location information into a format that can be accepted by the second server.

16. The method of claim 7, wherein the first network node converts the received location information into a postal code.

17. A method for enabling a user of a mobile communications device to identify a local vendor of a product or service, comprising:
receiving input from the user regarding a product or service which is of interest to the user;
determining the location of the mobile communications device through a location determination algorithm;
obtaining vendor information identifying vendors which are local to the determined location; and
obtaining status information identifying the availability of the product or service of interest at the identified vendors.

18. The method of claim 17, further comprising:
displaying the vendor information and status information on the mobile communications device.

19. The method of claim 17, wherein the product or service of interest to the user is a product, and further comprising:
displaying, on the mobile communications device, information about vendors local to the determined location which have the product in stock.

20. The method of claim 17, where location is determined (a) using the Global Positioning System, or (b) by using Cell Tower Triangulation of the known locations of one or more connected or nearby cell towers.
